(19) United States
(12) Patent Application Publication
(10) Pub. No.: US 2012/0308334 A1
(43) Pub. Date: Dec. 6, 2012

(54) MACHINE FOR FORMING AT LEAST ONE CREASE ON COVER BEFORE ATTACHMENT TO BOOK BINDING

(75) Inventors: Akira Nonoshita, Shiga (JP); Shinichi Takai, Shiga (JP); Nobuyuki Kojima, Shiga (JP); Shigeru Wakimoto, Shiga (JP); Takehito Yokogi, Shiga (JP)

(73) Assignee: HORIZON INTERNATIONAL INC., Shiga (JP)

(21) Appl. No.: 13/575,059

(22) PCT Filed: Feb. 2, 2010
(86) PCT No.: PCT/JP2010/051411

§ 371 Date: Jul. 25, 2012

(51) Int. Cl. B42C 11/04

(52) U.S. Cl. 412/11

(57) ABSTRACT

A cover S is fed between pairs of first and second feed rollers 2, 3; 4, 5 which synchronously rotate in the same direction, each of first and second creasing units 13, 14 composed of a fixed die 15 and a movable die 16 is disposed between the pairs of first and second feed rollers, the fixed and movable dies are opposite to each other and with a feed path F of the cover therebetween, a sensor 29 is disposed between the pair of first feed rollers 2, 3 and the first creasing unit 13 for detecting a front end of the cover, rotation number of the pairs of first and second feed rollers is controlled, the pairs of first and second feed rollers are stopped, the creasing unit is operated, and the movable die is pressed on the fixed die every time the cover is fed by a predetermined length from the sensor so that at least one crease is formed on the cover.

### TECHNICAL FIELD OF THE INVENTION

The present invention relates to a machine for forming at least one crease on a cover before attachment to a book block in a perfect book binding process, the cover has a front-cover-forming area, a back-cover-forming area and a spine-forming area disposed therebetween, the spine-forming area of the cover is attached to a spine of the book block, and thereafter the cover is folded.

### BACKGROUND OF THE INVENTION

A conventional perfect book binding apparatus, for example, comprises: a series of process units (a milling unit, a gluing unit and a cover attachment unit) arranged along a book block feed path for performing a book binding process; a clamp unit arranged for driving reciprocal movement along the book block feed path; and a clamp unit drive mechanism for reciprocal movement of the clamp unit. The clamp unit has a pair of clamp plates. The perfect book binding process is performed while the book block clamped by the clamp plates is sequentially passed through the process units.

In the perfect book binding apparatus, the clamp plates are composed of a fixed clamp plate and a movable clamp plate. The clamp unit comprises a gap adjusting mechanism for moving the movable clamp plate in directions toward and away from the fixed clamp plate. There is a book block insert position upstream of the milling unit. The book block is placed at its spine on a jogging plate which is arranged at the book block insert position, and inserted into a gap between the clamp plates of the clamp unit and clamped by them, and thereafter fed to the milling unit by the clamp unit along the book block feed path.

The milling unit comprises a milling cutter. While the book block clamped by the clamp plates is passed through the milling unit, a preprocessing is performed in such a way that the spine of the book block is uniformly grinded so as to apply glue to an entire of the spine of the book block. And then the book block clamped by the clamp plates is fed to the gluing unit.

The gluing unit comprises a glue tank, a gluing roller and so on. While the book block clamped by the clamp plates is passed through the gluing unit, glue is applied to the spine of the book block. And then the book block clamped by the clamp plates is fed to the cover attachment unit.

The cover attachment unit comprises a bottom plate and a pair of nip plates on the bottom plate. The nip plates are composed of a fixed nip plate and a movable nip plate. A gap between the fixed and movable nip plates are preliminary adjusted according to a thickness of the book block in a standby position. When the book binding process is started, the cover is fed from a cover supply portion onto both of the bottom plate and the nip plates. Next, the book block clamped by the clamp plates is stopped at a position where the spine of the book block is aligned with a spine-forming area of the cover. And then the bottom plate and the nip plates are moved upward so that the cover is pressed on the spine of the book block by the bottom plate, at the same time the movable nip plate is moved in a direction toward the fixed nip plate and the cover is pressed on the both sides of the book block in the neighborhood of corners of the spine of the book block. Thereby the cover is attached to the spine of the book block and folded at the corners of the spine of the book block so as to form a book. After the clamp unit is returned to the book block insert position, the clamp plates are opened maximally so as to discharge the book.

In the conventional perfect book binding apparatus, as above described, the cover is merely pressed on the sides of the book block by the nip plates of the cover attachment unit. Therefore, in the case that the cover is thick or relatively hard, the cover cannot be folded completely, which leads to a problem that the beautiful spine of the book with sharp corners cannot be obtained.

In order to solve the problem, some of conventional perfect book binding apparatuses comprise a creasing unit disposed in a middle way of a cover feed path between the cover supply portion and the nip plates so as to form two parallel creases on the cover at positions corresponding to the corners of the spine of the book block while the cover is fed from the cover supply portion onto the nip plates (see, for example, Patent Document 1).

The perfect book binding apparatus comprises: a drive shaft extending in a direction perpendicular to the cover feed path; a driven shaft extending in parallel to the drive shaft; first and third creasing rollers mounted on the drive shaft and disposed with spacing in an axial direction; second and fourth creasing rollers mounted on the driven shaft with spacing in an axial direction. Each of the first and third creasing rollers has a groove portion. Each of the second and fourth creasing rollers has a projection portion. The projection portion of the second creasing roller is fitted into the groove portion of the first creasing roller to form a pair of first creasing rollers. The projection portion of the fourth creasing roller is fitted into the groove portion of the third creasing roller to form a pair of second creasing rollers.

The cover is passed through each of gaps of the pairs of first and second creasing rollers while the cover is fed from the cover supply portion onto the nip plate, whereby two parallel creases are formed on the cover.

The pair of first creasing rollers is mounted on the drive and driven shafts for slide movement. Meanwhile the pair of second creasing rollers is fixed on the drive and driven shafts.

The creasing unit comprises: a guide rod extending parallel to the drive shaft; a movable block mounted on the guide rod for slide movement; a feed screw extending parallel to the guide rod for rotation around an axis thereof; and a motor for rotating the feed screw. The movable block has a thorough hole which has thread grooves corresponding to the feed screw, the feed screw is engaged with the through hole, and the movable block can be slid along the feed screw by rotation of the feed screw. The movable block is provided with a projection which has a bearing. The bearing of the movable block is fitted into a recess of the first creasing roller. A distance between the pairs of first and second creasing rollers can be changed by slide movement of the movable block which caused by rotation of the feed screw.

A pair of guide plates for adjusting a position where the cover is supplied from the cover supply portion is provided and a mechanism for adjusting positions of the nip plates is also provided so as to admit the change of a center position of the spine-forming area of the cover caused by the change of the distance between the pairs of first and second creasing rollers.

As above described, the distance between the pairs of first and second creasing rollers can be changed, and the positions of the guide nips of the cover supply portion and the positions of the nip plates are adjusted according to the thickness of the book block. As a result, two parallel creases are formed on the cover at positions corresponding to the corners of the spine of the book block.

When the book in the same thickness is mass-produced, the conventional creasing unit achieves good production efficiency because it is not necessary to change the distance between the pairs of first and second creasing rollers after a default setting of the distance is conducted. However, when various kinds of books of different thickness are produced in small lots, it is necessary to move the pair of first creasing rollers so as to change the distance between the pairs of first and second rollers every time the thickness of the book is changed, which leads to a problem that the production efficiency becomes decreased because a lot of time and effort are wasted and the apparatus is often stopped temporarily.

It is necessary to change the gap between the drive and driven shafts of the creasing unit when the thickness of the cover is changed. The provision of the mechanism for changing the gap between the shafts causes problems that the apparatus becomes complex and production efficiency becomes decreased.
Patent Document 1: JP 2003-291562 A

### SUMMARY OF THE INVENTION

### Problems to be Solved by the Invention

It is an object of the present invention to provide a machine which can form at least one crease on a cover without decreasing product efficiency even if various kinds of the books of different thickness are produced in small lots or various kinds of the covers of different thickness are used.

### Solution to the Problems

In order to achieve the objects, the present invention provides a machine for forming at least one crease on a cover before attachment to a book block in a perfect book binding process, the cover having a front-cover-forming area, a back-cover-forming area and a spine-forming area disposed therebetween, the spine-forming area of the cover being attached to a spine of the book block, and thereafter the cover being folded, the machine comprising:

a frame;

a pair of horizontal first feed rollers attached to the frame;

a pair of horizontal second feed rollers attached to the frame and arranged parallel to the pair of first feed rollers with spacing, a gap between the pair of second feed rollers being disposed opposite to a gap between the pair of first feed rollers;

a roller drive mechanism attached to the frame for synchronously rotating the pairs of first and second feed rollers in the same direction, the cover being inserted into the gap between the pair of first feed rollers, being fed between the pairs of first and second feed rollers and being discharged from the gap between the pair of second feed rollers; and

a first creasing unit attached to the frame and disposed between the pairs of first and second feed rollers, the first creasing unit forming the at least one crease on the cover; wherein

the first creasing unit comprises:
a horizontal fixed die attached to the frame and disposed above or below a feed path of the cover, the fixed die extending in a direction perpendicular to the feed path;
a horizontal movable die disposed opposite to the fixed die, the feed path extending between the fixed and movable dies, the movable die extending in a direction perpendicular to the feed path, one of the fixed and movable dies having a straight groove which has a V-shaped cross section and extends in a direction perpendicular to the feed path, the other having a straight projection which corresponds to the groove and extends in a direction perpendicular to the feed path;
a guide attached to the frame for guiding the movable die in a vertical direction;
a die drive mechanism for moving the movable die along the guide between first and second positions, the movable die being disposed away from the fixed die so as to retract from the feed path at the first position, the movable die being projected from the feed path so as to press on the fixed die in such a way that the groove and the projection are engaged with each other at the second position, whereby at least one straight crease is formed on the cover disposed between the fixed and movable dies while the movable die reciprocates between the first and second positions;
a sensor disposed between the pair of first feed rollers and the first creasing unit for detecting a passage of a front end of the cover; and
a control unit for controlling the roller and die drive mechanisms based on a predetermined distance from the sensor to a position to be provided with the crease by the first creasing unit, a preset length from the front end of the cover to a center of the spine-forming area or a preset length from the front end of the cover to an end of the spine-forming area closest to the front end of the cover, and a preset thickness of the book block, whereby
the roller drive mechanism is stopped and the movable die of the first creasing unit is reciprocated every time the cover is fed by a predetermined length from the sensor so that two parallel creases are formed on the cover at positions corresponding to both corners of the spine of the book block.

According to a preferred embodiment of the present invention, a position of the fixed die of the first creasing unit is changeable vertically.

According to another preferred embodiment of the present invention, the control unit controls the roller and die drive mechanisms in such a way that a single crease instead of the parallel two creases is formed on the cover at a position corresponding to the center of the spine of the book block when the thickness of the book block is smaller than a predetermined value.

According to another preferred embodiment of the present invention, the roller drive mechanism comprises: a first pulley mounted on a rotary shaft of a first drive roller; a second pulley mounted on a rotary shaft of a second drive roller; a first motor fixed on the frame and provided with a horizontal drive shaft; a third pulley mounted on the drive shaft of the first motor; and a first timing belt extending between the first, second and third pulleys.

According to another preferred embodiment of the present invention, the die drive mechanism comprises;
a horizontal rotary shaft attached to the frame and extending parallel to and below the movable die, the rotary shaft being rotatable around axis thereof;
a plurality of same-shaped cams mounted on the rotary shaft and spaced from each other in an axial direction of the rotary shaft, a periphery of each of the cams abutting a lower end of the movable die;
a fourth pulley mounted on the rotary shaft;
a second motor fixed on the frame and provided with a horizontal drive shaft;
a fifth pulley mounted on the drive shaft of the second motor; and
a second timing belt extending between the fourth and fifth pulleys, one rotation of the second motor affecting one reciprocal movement of the movable die.

According to another preferred embodiment of the present invention, the machine further comprises:
a touch-panel display for receiving input of data of the length from the front end of the cover to the center of the spine-forming area or the length from the front end of the cover to the end of the spine-forming area closest to the front end of the cover, and data of the thickness of the book block; and
a memory for storing the data inputted through the touch-panel display.

According to another preferred embodiment of the present invention, the machine is arranged adjacent a perfect book binding apparatus,

the perfect book binding apparatus comprises:
a series of process units arranged along a book block feed path for performing a perfect book binding process;
a clamp unit arranged for reciprocal movement along the book block feed path and provided with a pair of clamp plates, the perfect book binding process being performed while the book block clamped by the clamp plates sequentially is passed through the process units; and
a thickness detector for detecting the thickness of the book block when the book block is clamped by the clamp plates; wherein

the machine comprises;
a touch-panel display for receiving input of data of the length from the front end of the cover to the center of the spine-forming area or the length from the front end of the cover to the end of the spine-forming area closest to the front end of the cover; and
a memory for storing the data inputted through the touch-panel display, a detecting signal being sent from the thickness detector to the machine and the data of the thickness of the book block being stored in the memory by which the preset thickness of the book block is inputted to the machine.

According to another preferred embodiment of the present invention, in the case that outward fold lines are formed in the front-cover-forming and back-cover-forming areas of the cover adjacent the corners of the spine of the book block,
the machine further comprises a second creasing unit disposed between the first creasing unit and the pair of second feed rollers or between the sensor and the first creasing unit, wherein
positional relations of the groove and the projection of each of the first and second creasing units are reversed, the die drive mechanism of the second creasing unit is controlled by the control unit, wherein
the control unit controls the roller and die drive mechanisms based on a predetermined distance between positions to be provided with the creases by the pairs of first and second creasing units and a preset length between the end of the back-cove-forming area of the cover and the outward fold line together with the predetermined distance from the sensor to the position to be provided with the crease by the first creasing unit, the preset length from the front end of the cover to the center of the spine-forming area or the preset length from the front end of the cover to the end of the spine-forming area closest to the front end of the cover, and the preset thickness of the book block, whereby
the roller drive mechanism is stopped and the movable die of the second creasing unit is reciprocated every time the cover is fed by a predetermined length from the sensor so that each of the creases is formed at a position of the cover to be provided with the outward fold lines.

According to another preferred embodiment of the present invention, in the case that the cover has at least one turn-back area outside of the front-cover-forming area and/or the back-cover-forming area,
the control unit controls the roller and die drive mechanisms based on a preset depth of a front cover or a back cover together with the predetermined distance from the sensor to the position to be provided with the crease by the first creasing unit, the predetermined distance between the positions to be provided with the creases by the pairs of first and second creasing units, the preset length from the front end of the cover to the center of the spine-forming area or the preset length from the front end of the cover to the end of the spine-forming area closest to the front end of the cover, and the preset thickness of the book block, whereby
the roller drive mechanism is stopped and the movable die of the second creasing unit is reciprocated every time the cover is fed by a predetermined length from the sensor so that each of the creases is formed at a position of the at least one turn-back area to be provided with the fold line.

According to another preferred embodiment of the present invention, the machine further comprises:
a touch-panel display for receiving input of data of the length from the front end of the cover to the center of the spine-forming area or the length from the front end of the cover to the end of the spine-forming area closest to the front end of the cover, data of the thickness of the book block, data of a width of side area of the book block, and data of a depth of a front cover or a back cover; and
a memory for storing the data inputted through the touch-panel display.

According to another preferred embodiment of the present invention, the machine is arranged adjacent a perfect book binding apparatus, wherein

the perfect book binding apparatus comprises:
a series of process units arranged along a book block feed path for performing a perfect book binding process;
a clamp unit disposed for reciprocal movement along the book block feed path and provided with a pair of clamp plates, the perfect book binding process being performed while the book block clamped by the clamp plates sequentially is passed through the process units; and
a thickness detector for detecting the thickness of the book block when the book block is clamped by the clamp plates; wherein

the machine comprises;
a touch-panel display for receiving input of data of the length from the front end of the cover to the center of the spine-forming area or the length from the front end of the cover to the end of the spine-forming area closest to the front end of the cover, data of the distance from the corner of the book block to the outward fold line, and data of the depth of the front cover or the back cover; and
a memory for storing the data inputted through the touch-panel display, a detecting signal being sent from the thickness detector to the machine and the data of the thickness of the book block being stored in the memory by which the preset thickness of the book block is inputted to the machine.

According to another preferred embodiment of the present invention, the machine further comprises;

at least one support plate arranged between the pairs of first and second feed rollers and below the feed path for supporting a lower surface of the cover.

### Effect of the Invention

According to the present invention, the cover is fed between the pairs of first and second feed rollers which synchronously rotate in the same direction, the creasing unit composed of the fixed and movable dies is disposed between the pairs of first and second feed rollers, the fixed and movable dies are disposed opposite to each other and with the feed path of the cover therebetween, and the sensor is disposed for detecting the front end of the cover between the pair of first feed rollers and the creasing unit. Further, the pairs of first and second feed rollers are stopped, the creasing unit is operated and the movable die is pressed on the fixed die every time the cover is fed by the predetermined length from the sensor, thereby at least one crease is formed on the cover. As a result, the pairs of first and second feed rollers are stopped and the creasing unit is operated every time the cover area to be provided with the crease is arrived at the position of the dies of the creasing unit while the cover is fed between the pairs of first and second feed rollers, whereby it is possible to form the crease on the cover at a predetermined position. Further, if the thickness of the book is changed, it is possible to easily change the position of the crease of the cover by just changing the stop position of the cover relative to the dies during the operation of the creasing unit, and it is not necessary to stop the machine for adjustment. Therefore, according to the invention, it is possible to form the crease on the cover without decreasing product efficiency even if various kinds of the books of different thickness are produced in small lots or various kinds of the covers of different thickness are used.

Further, according to the present invention, it is possible to easily change a gap between the groove and the projection at the time when the movable die is arrived at the second position (when the crease is formed on the cover) by just changing the position of the fixed die of the creasing unit, whereby it is possible to rapidly and easily adapt various kinds of the covers of different thickness.

### BRIEF DESCRIPTION OF THE DRAWING

FIG. 1A is a perspective view showing the machine according to one embodiment of the present invention.

FIG. 1B is a perspective view showing the machine of FIG. 1A, in which the frame, a body cover, the drive mechanisms and so on are removed.

FIG. 2 is a perspective view showing a schematic structure of main elements of the machine of FIG. 1.

FIG. 3 is a plan view showing one example of a screen displayed on the touch-panel display of the machine of FIG. 1.

FIG. 4 is a perspective view showing the machine of FIG. 1 which is arranged adjacent the perfect book binding apparatus.

FIG. 5 is a side view showing the machine of FIG. 1, illustrating the movement of the machine.

FIG. 6 is a plan view showing various patterns of the crease(s) formed on the cover by the machine of FIG. 1.

FIG. 7 is a perspective view showing the cover attached to the book block, in which one example of the pattern of the creases is performed on the cover by the machine of FIG. 1.

### DETAILED EXPLANATION OF THE PREFERRED EMBODIMENTS

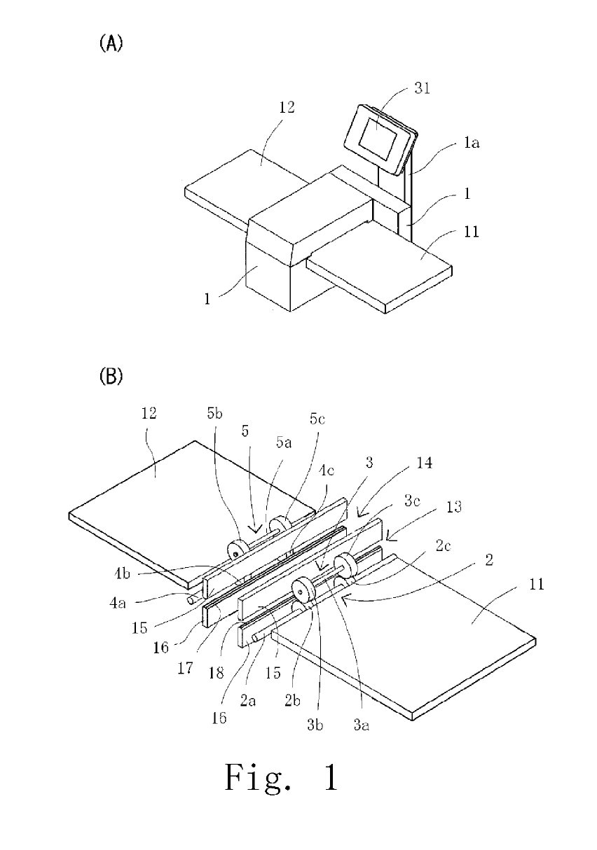

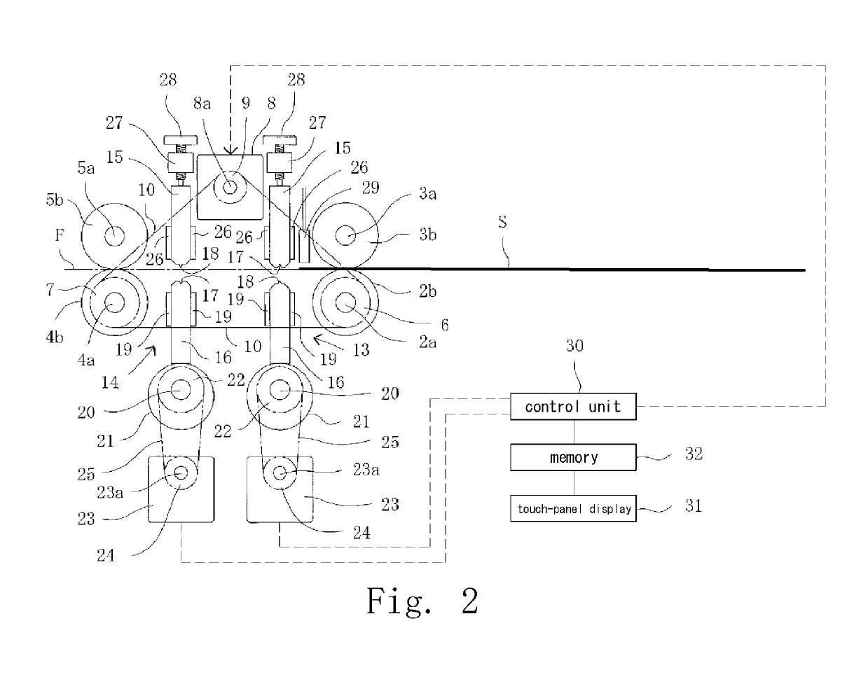

A preferred embodiment of the present invention will be explained below with reference to the accompanying drawings. FIG. 1A is a perspective view showing the machine according to one embodiment of the present invention. FIG. 1B is a perspective view showing the machine of FIG. 1A, in which the frame, a body cover, the drive mechanisms and so on are removed. FIG. 2 is a perspective view showing a schematic structure of main elements of the machine of FIG. 1.

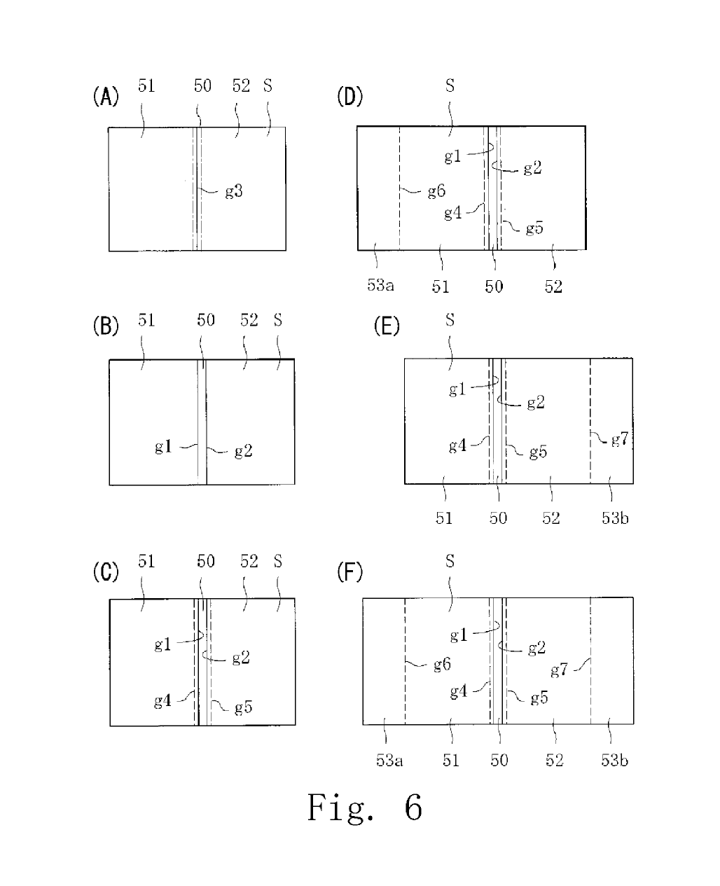

The machine of the present invention is used in a perfect book binding process. As shown in FIGS. 6A-6C, for example, the cover S has a front-cover-forming area 51, a back-cover-forming area 52 and a spine-forming area 50 disposed therebetween. Further, as shown in FIGS. 6D-6F, the cover S has at least one turn-back area 53a, 53b outside of the front-cover-forming area 51 and/or the back-cover-forming area 52 together with the spine-forming area 50, the front-cover-forming area 51 and the back-cover-forming area 52. In the perfect book binding process, the spine-forming area of the cover S is attached to a book block at its spine, and thereafter the cover S is folded.

As shown in FIGS. 1 and 2, the machine comprises a frame 1, a pair of horizontal first feed rollers 2, 3 attached to the frame 1, and a pair of horizontal second feed rollers 4, 5 attached to the frame 1 and arranged parallel to the pair of first feed rollers 2, 3 with spacing.

The pair of first feed rollers 2, 3 is composed of a first drive roller 2 and a first idle roller 3 which are adjacent to each other vertically. In this embodiment, the first drive roller 2 is composed of two rollers 2b, 2c which are fixed on a common rotary shaft 2a and spaced from each other in an axial direction, and the first idle roller 3 is composed of two rollers 3b, 3c which are fixed on a common rotary shaft 3a and spaced from each other in an axial direction. Each of the rollers 2b, 2c of the first drive roller 2 is contacted with each of the rollers 3b, 3c of the first idle roller 3.

The pair of second feed rollers 4, 5 is composed of a second drive roller 4 and a second idle roller 5 which are adjacent to each other vertically. In this embodiment, the second drive roller 4 is composed of two rollers 4b, 4c which are fixed on a common rotary shaft 4a and spaced from each other in an axial direction, and the second idle roller 5 is composed of two rollers 5b, 5c which are fixed on a common rotary shaft 5a and spaced from each other in an axial direction. Each of the rollers 4b, 4c of the second drive roller 4 is contacted with each of the rollers 5b, 5c of the second idle roller 5.

A gap between the pair of second feed rollers 4, 5 is opposite to a gap between the pair of first feed rollers 2, 3.

A first pulley 6 is fixed on the rotary shaft 2a of the first drive roller 2. A second pulley 7 is fixed on the rotary shaft 4a of the second drive roller 4. A first motor 8 is attached to the frame 1. The first motor 8 may preferably be composed of a stepping motor or a servomotor. The first motor 8 has a drive shaft 8a in parallel to the rotary shafts 2a, 4a. A third pulley 9 is fixed on the drive shaft 8a. A timing belt 10 is extended between the first, second and third pulleys 6, 7, 9.

Thus, a roller drive mechanism is composed of the first motor 8, the first, second and third pulleys 6, 7, 9 and the timing belt 10, and synchronously rotates the pairs of first and second feed rollers 2, 3; 4, 5.

However, the structure of the roller drive mechanism is not limited to this embodiment, and for example the roller drive mechanism can be composed of a known drive mechanism for synchronously rotating the pairs of first and second feed rollers 2, 3; 4, 5.

After the cover S is inserted into the gap between the pair of first feed rollers 2, 3 and fed between the pairs of first and second feed rollers 2, 3; 4, 5, the cover S is discharged from the pair of second feed rollers 4, 5. A distance between the pairs of first and second feed rollers 2, 3; 4, 5 is predetermined to be shorter than a length of the cover S in its feed direction.

Each of horizontal first and second tables 11, 12 for supporting a lower surface of the cover S is disposed at each of both an entrance side of the gap between the pair of first feed rollers 2, 3 and an exit side of the gap between the pair of second feed rollers 4, 5. These tables 11, 12 are provided if necessary.

The machine according to the invention comprises a first creasing unit 13 attached to the frame 1 and disposed between the pairs of first and second feed rollers 2, 3; 4, 5. The first creasing unit 13 forms a concave crease on one surface of the cover S. The machine comprises a second creasing unit 14 attached to the frame 1 and disposed between the first creasing unit 13 and the pair of second feed rollers 4, 5. The second creasing unit 14 forms a concave crease on the other surface of the cover S.

In this case the second creasing unit 14 is disposed downstream of the first creasing unit 13 in the feed direction of the cover S, but the second creasing unit 14 may be disposed upstream thereof.

The first and second creasing units 13, 14 will be explained below. The second creasing unit 14 is the same as the first creasing unit 13 in structre with the exception that positional relations of the groove and the projection formed on dies are reversed. Thus, the first creasing unit 13 will be explained below, and the explanation of the second creasing unit 14 is omitted.

The first creasing unit 13 comprises a horizontal fixed die 15 attached to the frame 1 and disposed above or below the feed path F of the cover S. In this embodiment, the fixed die 15 is disposed above the feed path F of the cover S. The fixed die 15 extends in a direction perpendicular to the feed path F. The first creasing unit 13 comprises a horizontal movable die 16 opposite to the fixed die 15. The movable die 16 extends in a direction perpendicular to the feed path F. The fixed die 15 has a straight groove 17 which has a V-shaped cross section and extends in a direction perpendicular to the feed path F. The movable die 16 has a straight projection which has a cross section corresponding to the groove 17 of the fixed die 15 and extends in a direction perpendicular to the feed path F. On the other hand, in the second creasing unit 14, the movable die 16 has a groove 17, meanwhile, the fixed die 15 has a projection.

The movable die 16 is guided in vertical direction by guides 19 attached to the frame 1. The first creasing unit 13 comprises a die drive mechanism for moving the movable die 16 along the guides 19 between first and second positions. At the first position the movable die 16 is disposed away from the fixed die 15 so as to retract from the feed path F. At the second position the movable die 16 is projected from the feed path F so as to press on the fixed die 15 in such a way that the groove 17 and the projection 18 are engaged with each other. Thereby, the crease is formed on the cover S disposed between the fixed and movable dies 15, 16 while the movable die 16 reciprocates between the first and second positions. In this case, the concave crease is formed on one surface of the cover S by the first creasing unit 13, meanwhile, the concave crease is formed on the other surface of the cover S by the second creasing unit 14, because positional relations of the groove 17 and the projection 18 of each of the first and second creasing units 13, 14 is reversed.

The die drive mechanism comprises a horizontal rotary shaft 20 attached to the frame 1 and extending parallel to and below the movable die 16, and the rotary shaft 20 is rotatable around axis thereof. The die drive mechanism comprises a plurality of same-shaped cams 21 mounted on the rotary shaft 20 and spaced from each other in an axial direction of the rotary shaft 20, a periphery of each of the cams 21 abuts a lower end of the movable die 16.

The die drive mechanism comprises a fourth pulley 22 mounted on the rotary shaft 20, a second motor 23 fixed on the frame 1 and provided with a horizontal drive shaft 23, a fifth pulley 24 mounted on the drive shaft 23a of the second motor 23, and a second timing belt 25 extending between the fourth and fifth pulleys 22, 24. One rotation of the second motor 23 affects one reciprocal movement of the movable die 16. The second motor 23 is preferably composed of a stepping motor or a servomotor.

In this embodiment, the die drive mechanism is composed of cams, but the structure of the die drive mechanism is not limited to this embodiment. For example, the die drive mechanism may be composed of a slide crank mechanism, a cylinder mechanism or a feed screw mechanism driven by a motor.

In this embodiment, the fixed die 15 is guided by guides 26 attached to the frame 1 in a vertical direction, and a top end of the fixed die 15 is connected with a screw 28 which is rotatable around its axis. A support block 27 is attached to the frame 1 and has a threaded through hole, and the screw 28 is engaged with the threaded through hole. A vertical position of the fixed die 15 is changeable by rotation of the screw 28.

As above, the vertical position of the fixed die 15 is changeable, as a result, it is possible to easily change a gap between the groove 17 and the projection 18 at the time when the movable die 16 is arrived at the second position (when the crease is formed on the cover S), and it is possible to rapidly and easily adapt various kinds of the covers S of different thickness.

The machine according to the invention comprises a sensor 29 disposed between the pair of first feed rollers 2, 3 and the first creasing unit 13 for detecting a passage of a front end of the cover S. If the second creasing unit 14 is disposed upstream of the first creasing unit 13, the sensor 29 is disposed between the pair of first feed rollers 2, 3 and the second creasing unit 14.

The machine according to the invention further comprises a control unit 30 for controlling the first motor 8 (the roller drive mechanism) and the second motor 23 (the die drive mechanism). A control unit 30 controls the pairs of first and second feed rollers 2, 3; 4, 5 based on data of a predetermined distance from the sensor 29 to a position to be provided with the crease by the first creasing unit 13 and/or data of a predetermined distance between positions to be provided with the creases by the first and second creasing units 13, 14, preset data of thickness of the book block, and data of length for defining a position to be provided with the crease. Thereby the roller drive mechanism is stopped and the movable dies 16 of the first and second creasing units 13, 14 are reciprocated every time the cover S is fed by a predetermined length from the sensor 29 so that the creases are formed on the cover S at predetermined position. For example, if the first motor 8 is composed of a stepping motor, the first motor 8 is controlled by an open-loop control by transmitting pulses to the stepping motor. For example, if the first motor 8 is composed of a servomotor, the first motor 8 is controlled by a closed-loop control (a feedback control) by using an encoder installed in the servomotor.

The machine according to the invention comprises a touch-panel display 31 for receiving input of data of length for defining a position to be provided with the crease of the cover S, and a memory 32 for storing the data inputted through the touch-panel display 31. As shown in FIG. 1A, the touch-panel display 31 is attached to a support post 1a which is provided on a side portion of the frame 1.

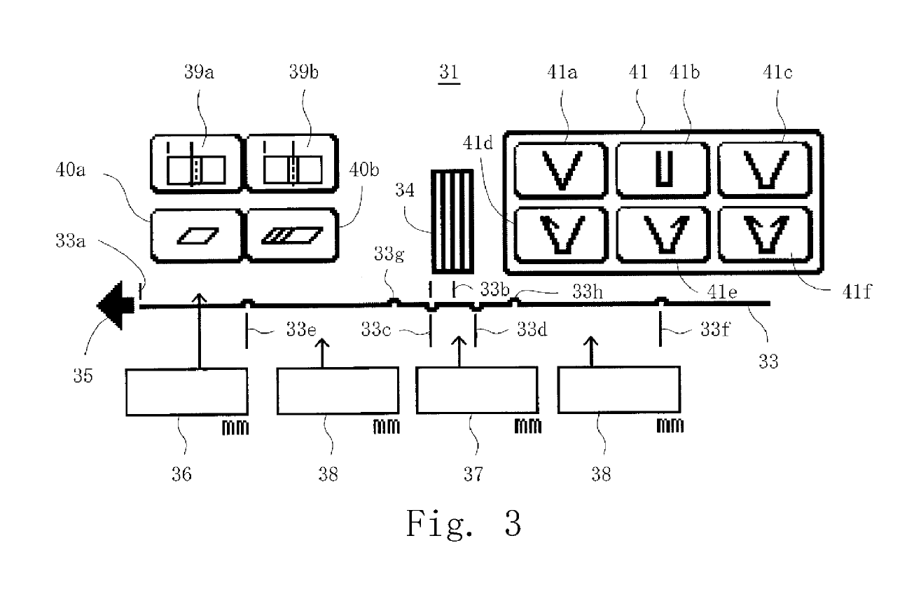

FIG. 3 is a plan view showing one example of a screen displayed on the touch-panel display of the machine of FIG. 1. As shown in FIG. 3, there are an image 33 of the cover extending horizontally and an image 34 of the book block above a center of the image 33 of the cover on the touch-panel display 31. These images 33, 34 correspond to side views as viewed from a top edge side (or a bottom edge side) of the book block. An arrow 35 disposed at a left side of the image 33 of the cover indicates the feed direction of the cover S.

In the screen displayed on the touch-panel display 31, several lines for indicating several portions of the cover are disposed adjacent the image 33 of the cover. The lines are composed of a line 33a for indicating a position of the front end of the cover, a line 33b for indicating a position of the center of the spine-forming area, a line 33c for indicating a position of an end of the spine-forming area closest to the front end of the cover, a line 33d for indicating a position of an end of the spine-forming area farthest from the front end of the cover, and lines 33e, 33f for indicating positions of fold lines of turn-back areas. Each of characters of “33g” and “33h” provided on the image 33 of the cover S indicates outward fold line which is formed in the front-cover-forming area and the back-cover-forming area of the cover adjacent corners of the book block.

In the screen, first, second and third data input columns 36, 37, 38 are disposed below the image 33 of the cover so as to receive data of lengths for defining positions to be provided with the creases. The first data input column 36 receives data of a length from the front end 33a of the cover to the center 33b of the spine-forming area (hereinafter referred to as “a first reference length”) or a length from the front end 33a of the cover to the end 33c of the spine-forming area closest to the front end 33a of the cover (hereinafter referred to as “a second reference length”) in the millimeter. The second data input column 37 receives data of a thickness of the book block (a length between the ends 33c, 33d of the spine-forming area) in the millimeter. The third data input columns 38 receives data of lengths from the ends 33c, 33d of the spine-forming area of the cover to the fold lines 33e, 33f of the turn-back area (a depth between a front cover and back cover) in the millimeter.

In this embodiment, a length between the end 33c of the spine-forming area and the outward fold line 33g of the front-cover-forming area (at the same time, a length between the end 33d of the spine-forming area and the outward fold line 33h of the back-cover-forming area), for example 5 mm, is preset, but a forth data input column for receiving data of the length may be provided.

In this embodiment, the data are inputted to the data input columns 36-38 through a numeric keypad (not shown) which is arranged adjacent the touch-panel display 31. Each of the data input columns 36-38 is displayed in two different colors depending on whether the input of the data is required or not, thereby an operator can easily recognize a need for the input of the data.

In an upper left area of the touch-panel display 31, there are buttons 39a, 39b for determining whether the first or second reference length is inputted in the first data input column 36. When the first reference length is inputted in the first input column 36, the button 39b is touched, meanwhile, when the second reference length is inputted in the first input column 36, the button 39a is touched.

Buttons 40a, 40b are disposed below the buttons 39a, 39b so as to select a dialogic operation mode or a continuous operation mode. When the continuous operation mode is selected, the inputted data of the thickness of the book block cannot be changed. Meanwhile, when the dialogic operation mode is selected, the inputted data of the thickness of the book block can be changed. If the button 40a is touched to select the dialogic operation mode, the input of the data of the thickness of the book block is required to start the operation every time a creasing operation is completed. Meanwhile, if the button 40b is touched to select the continuous operation mode, the input of the data of the thickness of the book block is once required when the creasing operation starts.

In this embodiment, as shown in FIGS. 6A-6F, the machine according to the invention can form the creases on the cover S in six different patterns. In an upper right area 41 of the touch-panel display 31, there are six buttons 41a-41f for selecting one of the six different patterns of the creases.

If the thickness of the book block is smaller than a predetermined value and a single crease is formed on the cover at a position corresponding to the center of the spine of the book block, the button 41a is touched. When the button 41a is touched, it is required by the control unit 30 to input the data of the first or second reference length into the first data input column 36 and the data of the thickness of the book block into the second data input column 37. After the needed data are inputted into the first and second data input columns 36 and 37, the inputted data is stored in the memory 32.

The control unit 30 controls the roller and die drive mechanism based on the predetermined distance from the sensor 29 to the position to be provided with the crease by the first creasing unit 13, the first or second reference length (stored in the memory 32), and the thickness of the book block (stored in the memory 32). Thereby the roller drive mechanism is stopped and the movable die 16 of the first creasing unit 13 is reciprocated every time the cover S is fed by a predetermined length from the sensor 29 so that the single crease (g₃) is formed at the center of the spine-forming area 50 of the cover S, as shown in FIG. 6A.

If the two parallel creases are formed on the cover S at positions corresponding to both corners of the spine of the book block, the button 41b is touched. When the button 41b is touched, it is required by the control unit 30 to input the data of the first or second reference length into the first data input column 36 and the data of the thickness of the book block into the second data input column 37. After the needed data are inputted into the first and second data input columns 36 and 37, the inputted data is stored in the memory 32.

The control unit 30 controls the roller and die drive mechanism based on the predetermined distance from the sensor 29 to the position to be provided with the crease by the first creasing unit 13, the first or second reference length (stored in the memory 32), and the thickness of the book block (stored in the memory 32). Thereby the roller drive mechanism is stopped and the movable die 16 of the first creasing unit 13 is reciprocated every time the cover S is fed by a predetermined length from the sensor 29 so that the two parallel creases (g₁ and g₂) are formed on the both corners of the spine-forming area 50 of the cover S, as shown in FIG. 6B.

If the outward fold lines are formed in both of the front-cover-forming area 51 and the back-cover-forming area 52 of the cover S adjacent the corners of the spine of the book block, the button 41c is touched. When the button 41c is touched, it is required by the control unit 30 to input the data of the first or second reference length into the first data input column 36 and the data of the thickness of the book block into the second data input column 37. After the needed data are inputted into the first and second data input columns 36 and 37, the inputted data is stored in the memory 32.

The control unit 30 controls the roller and die drive mechanism based on the predetermined distance from the sensor 29 to the position to be provided with the crease by the first creasing unit 13, a predetermined distance between positions to be provided with the creases by the first and second creasing units 13 and 14, the first or second reference length (stored in the memory 32), the thickness of the book block (stored in the memory 32), and a predetermined length between the end 33c of the back-cover-forming area of the cover and the outward fold 33g. Thereby the roller drive mechanism is stopped and the movable dies 16 of the first and second creasing units 13, 14 are reciprocated every time the cover S is fed by a predetermined length from the sensor 29 so that each of the creases (g₄ and g₅) is formed at a position corresponding to each of the outward fold lines of the front-cover-forming area 51 and the back-cover-forming area 52 together with the two parallel creases (g₁ and g₂) formed on the both corners of the spine-forming area 50 of the cover S, as shown in FIG. 6C.

If the cover S has at least one turn-back area outside of the front-cover-forming area 51 and/or the back-cover-forming area 52, any one of three buttons 41d-41f is appropriately touched. When one of the buttons 41d-41f is touched, it is required by the control unit 30 to input the data of the first or second reference length into the first data input column 36, the data of the thickness of the book block into the second data input column 37, and a data of a depth of a front cover or a back cover into the third data input column 38. After the needed data are inputted into the first, second and third data input columns 36-38, the inputted data is stored in the memory 32.

The control unit 30 controls the roller and die drive mechanism based on the predetermined distance from the sensor 29 to the position to be provided with the crease by the first creasing unit 13, a predetermined distance between positions to be provided with the creases by the first and second creasing units 13 and 14, the first or second reference length (stored in the memory 32), the thickness of the book block (stored in the memory 32), and the predetermined length between the end 33c of the back-cover-forming area of the cover and the outward fold 33g, and the depth of the front cover or the back cover (stored in the memory 32). Thereby the roller drive mechanism is stopped and the movable dies 16 of the first and second creasing units 13, 14 are reciprocated every time the cover S is fed by a predetermined length from the sensor 29 so that each of the creases (g₆ and g₇) is formed at a position corresponding to each of the fold lines of the turn-back areas 53a, 53b of the cover S together with the two parallel creases (g₁ and g₂) formed at the both corners of the spine-forming area 50 of the cover S and each of the creases (g₄ and g₅) formed at a position corresponding to each of the outward fold lines of the front-cover-forming area 51 and the back-cover-forming area 52, as shown in FIGS. 6D-6F.

Next, movement of the machine according to the invention will be explained below. In the explanation, the creases are formed in the pattern shown in FIG. 6C. At first, the button 41c of the touch-panel display 31 of FIG. 3 is touched to select the pattern of FIG. 6C. In this embodiment, the first motor 8 for rotating the pairs of first and second feed rollers 2, 3; 4, 5 is composed of a stepping motor, the button 39b is touched to select the input of the first reference length, and the button 40b is touched to select the continuous operation mode.

And, the length (mm) from the front end 33a of the cover S to the center 33b of the spine-forming area is inputted into the first data input column 36, the thickness (mm) of the book block is inputted into the second data input column 37, and the inputted data are stored in the memory 32.

In this embodiment, it is necessary to stop the cover S two times at positions to be provided with the creases by the first creasing unit 13 and further stop the cover S two times at positions to be provided with the creases by the second creasing unit 14 while the cover S is fed between the pairs of first and second feed rollers 2, 3; 4, 5, because, as shown in FIG. 6C, the two creases (g₁ and g₂) are formed by the first creasing unit 13 and the two creases (g₄ and g₅) are formed by the second creasing unit 14. The control unit 30 calculates based on the predetermined distance (a) from the sensor 29 to the position to be provided with the crease by the first creasing unit 13, a predetermined distance (b) between positions to be provided with the creases by the first and second creasing units 13 and 14, the first reference length (c) (stored in the memory 32), the thickness (d) of the book block (stored in the memory 32), and a predetermined length (e) between the end 33c of the back-cover-forming area of the cover and the outward fold line 33g. Thereby, each of the feed lengths of the cover S from the sensor 29 to each of four stop positions of the cover S is calculated by the following equations:

(I) For the first stop position (where the crease (g₁) is formed by the first creasing unit 13)

The feed length of the cover S (a first feed length)=c−(d/2)+a

(II) For the second stop position (where the crease (g₂) is formed by the first creasing unit 13)

The feed length of the cover S (a second feed length)=c+(d/2)+a

(III) For the third stop position (where the crease (g₄) is formed by the second creasing unit 14)

The feed length of the cover S (a third feed length)=c−(d/2)−e+(a+b)

(IV) For the fourth stop position (where the crease (g₅) is formed by the second creasing unit 14)

The feed length of the cover S (a fourth feed length)=c+(d/2)+e+(a+b)

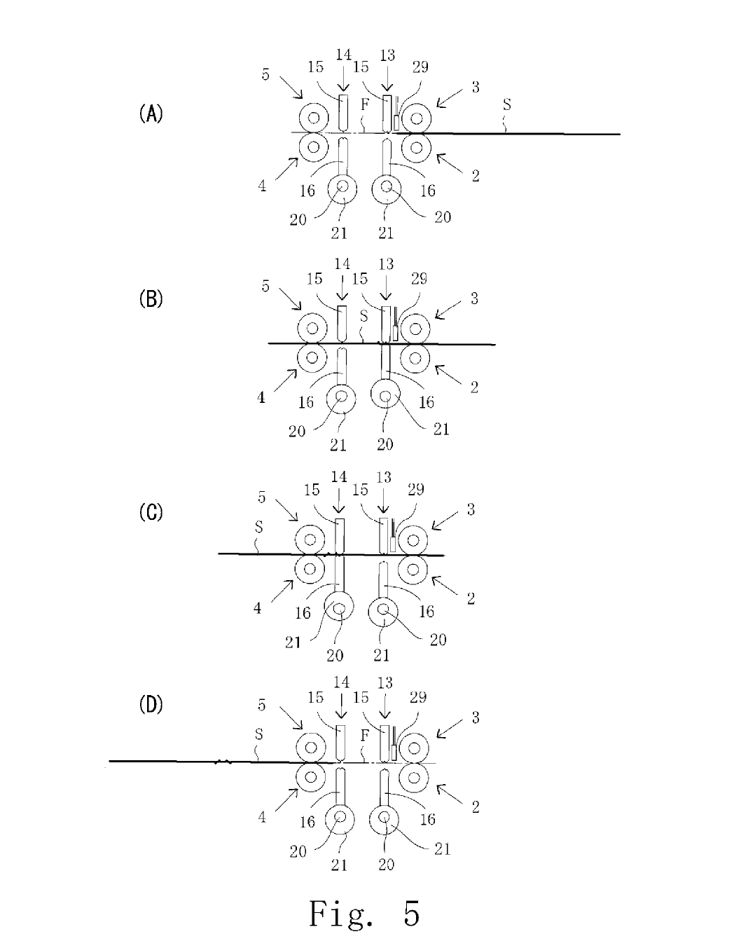

When a start button of the machine is touched, rotation of the pairs of first and second feed roller 2, 3; 4, 5 is started. Then, the cover S is placed on the table 11 and the front end of the cover S is inserted into the gap between the pair of first feed rollers 2, 3. After the front end of the cover S is detected by the sensor 29 (FIG. 5A), the control unit 30 transmits pulses to the first motor 8 so as to stop the cover S at a position where the cover S is fed by the first feed length. The control unit 30 operates the first creasing unit 13 to form the crease (g₁) on the cover S. And the control unit 30 transmits pulses to the first motor 8 so as to stop the cover S at a position where the cover S is fed by the second feed length. The control unit 30 operates the first creasing unit 13 to form the crease (g₂) on the cover S (FIG. 5B). And the control unit 30 transmits pulses to the first motor 8 so as to stop the cover S at a position where the cover S is fed by the third feed length. The control unit 30 operates the second creasing unit 14 to form the crease (g₄) on the cover S. And the control unit 30 transmits pulses to the first motor 8 so as to stop the cover S at a position where the cover S is fed by the fourth length. The control unit 30 operates the second creasing unit 14 to form the crease (g₅) on the cover S (FIG. 5C). And then, the control unit 30 transmits pulses to the first motor 8 so as to discharge the finished cover S provided with the creases from the gap between the pair of second feed rollers 4, 5 (FIG. 5D) onto the table 12 of the machine.

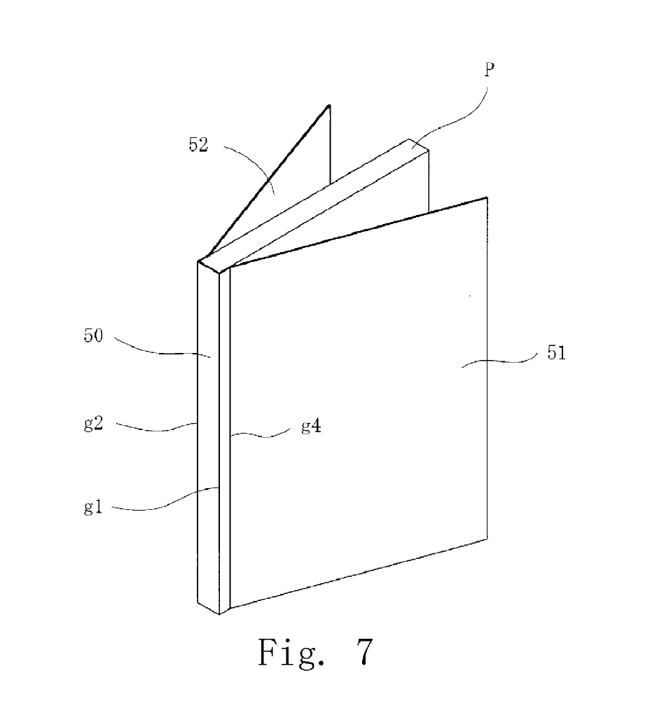

The finished cover S provided with the creases is attached to the spine of the book block P by a perfect book binding apparatus, as shown in FIG. 7. The cover S is folded at a right angle along the side surfaces of the book block P at the two creases (g₁ and g₂) corresponding to the both sides of the corners of the book block P. The cover S attached to the book block P can be easily and beautifully folded outwardly along the two creases (g₄ and g₅).

According to the invention, while the cover S is fed between the pairs of first and second feed rollers 2, 3; 4, 5, the crease(s) can be formed on the cover S at the predetermined position(s) by stopping the pairs of first and second feed rollers 2, 3; 4, 5 and operating the creasing unit(s) 13, 14 every time the area(s) of the cover S to be provided with the crease(s) is arrived at the position(s) of the die(s) of the creasing unit(s) 13, 14. Therefore, if the thickness of the book block P is changed, it is possible to easily change the position of the crease(s) of the cover S by just changing the stop position(s) of the cover S relative to the die(s) during the operation of the creasing unit(s) 13, 14, and it is not necessary to stop the machine for adjustment depending on the change of the thickness of the book block P. It is possible to form the crease on the cover S without decreasing product efficiency even if various kinds of the books of different thickness are produced in small lots or various kinds of the covers of different thickness are used.

One preferable embodiment of the present invention is explained, but the structural features of the present invention are not limited to this embodiment. For example, the two creasing units 13, 14 are disposed between the pairs of first and second feed rollers 2, 3; 4, 5 in this embodiment, but if the crease(s) is formed in the pattern shown in FIGS. 6A and 6B, a single creasing unit is disposed between the pairs of first and second feed rollers.

If a front end portion of a thin cover S is likely bent downward from the feed path F while being fed between the pairs of first and second feed rollers 2, 3; 4, 5, at least one support plate is disposed for supporting the lower surface of the cover S at an appropriate position below the feed path F.

In this embodiment the thickness of the book block is manually inputted through the touch-panel display 31, but the thickness of the book block can be automatically inputted into the machine by automatically measuring the thickness of the book block when the book block is set on the perfect book binding apparatus to transmit the measurement data to the machine of the invention.

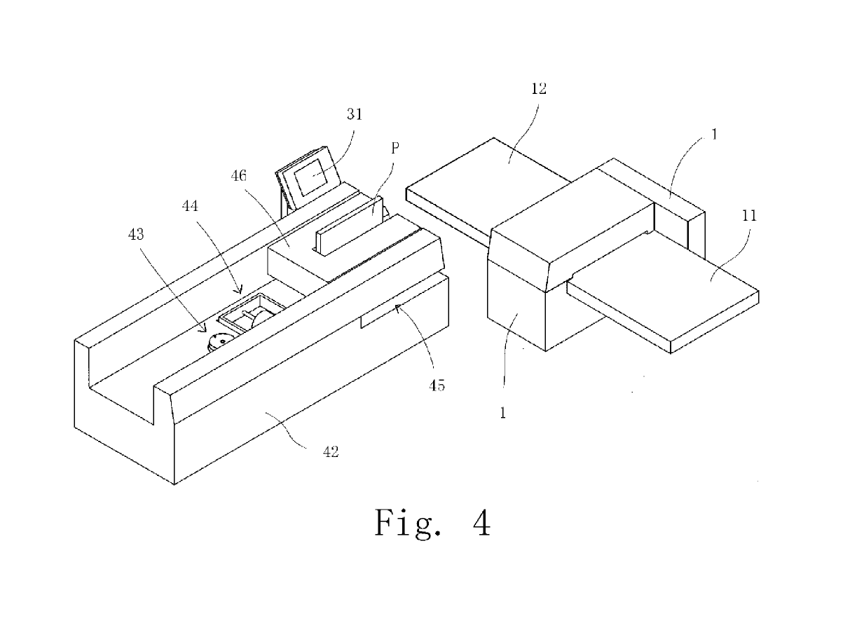

In this case, as shown in FIG. 4, the perfect book binding apparatus 42 comprises a series of process units (a milling unit 43, a gluing unit 44 and a cover attachment unit 45) arranged along a book block feed path for performing a book binding process, and a clamp unit 46 arranged for reciprocal movement along the book block feed path. The clamp unit 46 has a pair of clamp plates (not shown). The perfect book binding process is performed while the book block clamped by the clamp plates is sequentially passed through the process units 43-45. The perfect book binding apparatus 42 comprises a thickness detector (not shown) for detecting the thickness of the book block P when the book block P is clamped by the clamp plates. In this embodiment, the touch-panel display 31 is integrated in a touch-panel display of the perfect book binding apparatus 42.

A detecting signal is sent from the thickness detector of the perfect book binding apparatus 42 to the machine of the invention and the data of the thickness of the book block P is stored in the memory 32 of the machine by which the thickness of the book block is inputted to the machine.

### DESCRIPTION OF THE REFERENCE CHARACTERS

1 frame
1a support post
2 first drive roller
2a rotary shaft
2b, 2c roller
3 first idle roller
3a rotary shaft
3b, 3c roller
4 second drive roller
4a rotary shaft
4b, 4c roller
5 second idle roller
5a rotary shaft
5b, 5c roller
6 first pulley
7 second pulley
8 first motor
8a drive shaft
9 third pulley
10 first timing belt
11 first table
12 second table
13 first creasing unit
14 second creasing unit
15 fixed die
16 movable die
17 groove
18 projection
19 guide
20 rotary shaft
21 cam
22 fourth pulley
23 second motor
23a rotary shaft
24 fifth pulley
25 second timing belt
26 guide
27 support block
28 screw
29 sensor
30 control unit
31 touch-panel display
32 memory
F feed path
P book block
S cover

1. A machine for forming at least one crease on a cover before attachment to a book block in a perfect book binding process, the cover having a front-cover-forming area, a back-cover-forming area and a spine-forming area disposed therebetween, the spine-forming area of the cover being attached to a spine of the book block, and thereafter the cover being folded, the machine comprising:
a frame;
a pair of horizontal first feed rollers attached to the frame;
a pair of horizontal second feed rollers attached to the frame and arranged parallel to the pair of first feed rollers with spacing, a gap between the pair of second feed rollers being disposed opposite to a gap between the pair of first feed rollers;
a roller drive mechanism attached to the frame for synchronously rotating the pairs of first and second feed rollers in the same direction, the cover being inserted into the gap between the pair of first feed rollers, being fed between the pairs of first and second feed rollers and being discharged from the gap between the pair of second feed rollers; and
a first creasing unit attached to the frame and disposed between the pairs of first and second feed rollers, the first creasing unit forming the at least one crease on the cover; wherein
the first creasing unit comprises:
a horizontal fixed die attached to the frame and disposed above or below a feed path of the cover, the fixed die extending in a direction perpendicular to the feed path;
a horizontal movable die disposed opposite to the fixed die, the feed path extending between the fixed and movable dies, the movable die extending in a direction perpendicular to the feed path, one of the fixed and movable dies having a straight groove which has a V-shaped cross section and extends in a direction perpendicular to the feed path, the other having a straight projection which corresponds to the groove and extends in a direction perpendicular to the feed path;
a guide attached to the frame for guiding the movable die in a vertical direction;
a die drive mechanism for moving the movable die along the guide between first and second positions, the movable die being disposed away from the fixed die so as to retract from the feed path at the first position, the movable die being projected from the feed path so as to press on the fixed die in such a way that the groove and the projection are engaged with each other at the second position, whereby at least one straight crease is formed on the cover disposed between the fixed and movable dies while the movable die reciprocates between the first and second positions;
a sensor disposed between the pair of first feed rollers and the first creasing unit for detecting a passage of a front end of the cover; and
a control unit for controlling the roller and die drive mechanisms based on a predetermined distance from the sensor to a position to be provided with the crease by the first creasing unit, a preset length from the front end of the cover to a center of the spine-forming area or a preset length from the front end of the cover to an end of the spine-forming area closest to the front end of the cover, and a preset thickness of the book block, whereby the roller drive mechanism is stopped and the movable die of the first creasing unit is reciprocated every time the cover is fed by a predetermined length from the sensor so that two parallel creases are formed on the cover at positions corresponding to both corners of the spine of the book block.

2. The machine according to claim 1, wherein a position of the fixed die of the first creasing unit is changeable vertically.

3. The machine according to claim 1, wherein the control unit controls the roller and die drive mechanisms in such a way that a single crease instead of the parallel two creases is formed on the cover at a position corresponding to the center of the spine of the book block when the thickness of the book block is smaller than a predetermined value.

4. The machine according to claim 1, wherein the roller drive mechanism comprises:
a first pulley mounted on a rotary shaft of a first drive roller;
a second pulley mounted on a rotary shaft of a second drive roller;
a first motor fixed on the frame and provided with a horizontal drive shaft;
a third pulley mounted on the drive shaft of the first motor; and
a first timing belt extending between the first, second and third pulleys.

5. The machine according to claim 4, wherein the die drive mechanism comprises:
a horizontal rotary shaft attached to the frame and extending parallel to and below the movable die, the rotary shaft being rotatable around axis thereof;
a plurality of same-shaped cams mounted on the rotary shaft and spaced from each other in an axial direction of the rotary shaft, a periphery of each of the cams abutting a lower end of the movable die;
a fourth pulley mounted on the rotary shaft;
a second motor fixed on the frame and provided with a horizontal drive shaft;
a fifth pulley mounted on the drive shaft of the second motor; and
a second timing belt extending between the fourth and fifth pulleys, one rotation of the second motor affecting one reciprocal movement of the movable die.

6. The machine according to claim 5, further comprising:
a touch-panel display for receiving input of data of the length from the front end of the cover to the center of the spine-forming area or the length from the front end of the cover to the end of the spine-forming area closest to the front end of the cover, and data of the thickness of the book block; and
a memory for storing the data inputted through the touch-panel display.

7. The machine according to claim 5, wherein the machine is arranged adjacent a perfect book binding apparatus,
the perfect book binding apparatus comprises:
a series of process units arranged along a book block feed path for performing a perfect book binding process;
a clamp unit arranged for reciprocal movement along the book block feed path and provided with a pair of clamp plates, the perfect book binding process being performed while the book block clamped by the clamp plates sequentially is passed through the process units; and
a thickness detector for detecting the thickness of the book block when the book block is clamped by the clamp plates; wherein
the machine comprises;
a touch-panel display for receiving input of data of the length from the front end of the cover to the center of the spine-forming area or the length from the front end of the cover to the end of the spine-forming area closest to the front end of the cover; and
a memory for storing the data inputted through the touch-panel display, a detecting signal being sent from the thickness detector to the machine and the data of the thickness of the book block being stored in the memory by which the preset thickness of the book block is inputted to the machine.

8. The machine according to claim 1, wherein in the case that outward fold lines are formed in the front-cover-forming and back-cover-forming areas of the cover adjacent the corners of the spine of the book block,
the machine further comprises a second creasing unit disposed between the first creasing unit and the pair of second feed rollers or between the sensor and the first creasing unit, wherein positional relations of the groove and the projection of each of the first and second creasing units are reversed, the die drive mechanism of the second creasing unit is controlled by the control unit, wherein preset length from the front end of the cover to the center of the spine-forming area or the preset length from the front end of the cover to the end of the spine-forming area closest to the front end of the cover, and the preset thickness of the book block, whereby the roller drive mechanism is stopped and the movable die of the second creasing unit is reciprocated every time the cover is fed by a predetermined length from the sensor so that each of the creases is formed at a position of the at least one turn-back area to be provided with the fold line.

10. The machine according to claim 9, further comprising:
a touch-panel display for receiving input of data of the length from the front end of the cover to the center of the spine-forming area or the length from the front end of the cover to the end of the spine-forming area closest to the front end of the cover, data of the thickness of the book block, data of a width of side area of the book block, and data of the depth of a front cover or a back cover; and a memory for storing the data inputted through the touch-panel display.

11. The machine according to claim 9, wherein the machine is arranged adjacent a perfect book binding apparatus, wherein the perfect book binding apparatus comprises:
a series of process units arranged along a book block feed path for performing a perfect book binding process;
a clamp unit disposed for reciprocal movement along the book block feed path and provided with a pair of clamp plates, the perfect book binding process being performed while the book block clamped by the clamp plates sequentially is passed through the process units; and
a thickness detector for detecting the thickness of the book block when the book block is clamped by the clamp plates; wherein the machine comprises;
a touch-panel display for receiving input of data of the length from the front end of the cover to the center of the spine-forming area or the length from the front end of the cover to the end of the spine-forming area closest to the front end of the cover, data of a width of side area of the book block, and data of the depth of the front cover or the back cover; and
a memory for storing the data inputted through the touch-panel display, a detecting signal being sent from the thickness detector to the machine and the data of the thickness of the book block being stored in the memory by which the preset thickness of the book block is inputted to the machine.

12. The machine according to claim 1, further comprising;
at least one support plate arranged between the pairs of first and second feed rollers and below the feed path for supporting a lower surface of the cover.
